(19) United States
(12) Patent Application Publication
(10) Pub. No.: US 2006/0151222 A1
(43) Pub. Date: Jul. 13, 2006

(54) Engine compartment partitioning layer

(76) Inventor: Francesco Carlo Tinti, Milan (IT)

Correspondence Address: NATH & ASSOCIATES, 112 South West Street, Alexandria, VA, 22314, US

(21) Appl. No.: 10/541,824

(22) PCT Filed: Jan. 27, 2004
(86) PCT No.: PCT/CH04/00044

§ 371 Date: Jul. 11, 2005

(30) Foreign Application Priority Data
Jan. 27, 2003 (DE) 203-01-200.3

(51) Int. Cl. B62D 25/10

(52) U.S. Cl. 180/69.22; 296/39.3

(57) ABSTRACT

For the formation of a sound insulating and absorbing cavity (8) within an engine compartment (1), said engine compartment (1) is partitioned by means of a lightweight engine compartment partitioning layer (7). Said partitioning layer (7) can be made of several sections and forms an essentially cohesive surface within the engine compartment (1). In a preferred embodiment of the invention this partitioning layer (7) consists of a carrier layer (12) and a sound absorbent layer (13) and may comprise first and second water and oil repellent layers (14, 15). The cavity (8) created by this partitioning layer (7) leads to a substantive increase in transmission loss.

The present invention relates to an engine compartment partitioning layer for use in a motor vehicle engine compartment.

It is the aim of the modern automobile industry to provide vehicles which not only have an acoustically agreeable environment in the passenger compartment, but which also do not emit disturbing noise. In particular the knocking sounds in a low frequency range of 800-2000 Hz and other type-specific noise patterns emitted by diesel vehicles are considered undesirable by the automobile industry. Unpleasant noises in the high frequency range of 1000-5000 Hz emitted by engine aggregates are also not desirable.

In order to reduce the noise level emitted outwards, and in particular with heavy goods vehicles or trucks, it is known to encapsulate the motor, individual units (for example the gear box or transmission unit), or the whole engine bay, i.e. compartment, by wrapping these in insulating materials. As a rule, acoustically effective linings are provided in the engine compartment of conventional passenger vehicles, and in particular the engine hood and/or front wall is provided with sound damping layers. These linings are essentially in the form of sound insulating parts and only have limited acoustical efficacy.

These measures do not appear to fulfil the acoustic requirements preset by the automobile industry. Any improvement in the acoustic values of these linings results in an increase in thickness and weight of these linings.

It is therefore the aim of the present invention to further reduce noise emitted from the engine compartment in an efficient manner or to eliminate it completely. In particular, it is the aim of the present invention to provide lightweight and acoustically efficient means for reducing the emitted noise.

This is achieved according to the invention with an engine compartment partitioning layer comprising the features of claim 1. In the following, the term “partitioning layer” relates to any sheet-like component which is arranged between the engine hood and the base section of the engine compartment, and which divides the engine compartment, preferably horizontally.

By means of this partitioning layer an acoustically effective chamber or cavity is developed in the engine compartment with which the energy of the sound field produced by the engine or other vehicle units is diminished by absorbing and insulating effects.

In a preferred embodiment of the invention, this partitioning layer is arranged in such a manner that it lies essentially horizontally, i.e. parallel to the vehicle flooring, and a few centimeters, e.g. 4-5 cm, over the engine block. In this way an essentially closed and acoustically effective cavity is formed between the closed engine hood and this partitioning layer. The spatial arrangement of this acoustically effective cavity allows acoustic insulating effects and a number of different absorptive effects to be put to use. It is understood that the dimensions of this cavity can be adjusted by specifically designing the inventive partitioning layer according to particular acoustic requirements. Furthermore this partitioning layer can be provided with additional sound absorbing or heat insulating material in order to achieve a still more efficient solution to the problem.

In particular the acoustically effective cavity created by the engine compartment partitioning layer according to the invention essentially functions in the manner of a large Helmholtz resonator comprising sound absorptive and sound insulating walls. This allows the man skilled in the art to adjust the sound field emitted outwards from the vehicle in an easy and cost-effective way.

In a particular embodiment of the invention the engine compartment partitioning layer is formed of a plurality of mutually complementary sections which are joined together.

In yet another embodiment of the invention a number of engine compartment partitioning layers are arranged in the same engine compartment, thus resulting in the formation of several acoustically effective cavities. In particular, the individual partitioning layers can interact in the manner of Helmholtz resonators.

Other preferred embodiments of or developments to the present invention comprise the features of the dependent claims. In particular, the partitioning layer comprises a carrier layer and a sound absorbent layer. This carrier layer is made of a compressed phenolic resinous nonwoven layer or a suitable foam material. Preferably, the carrier layer is provided with a first water and oil repellent layer, in particular a textile scrim or felt layer, on the side towards the engine hood. Furthermore, the sound absorbent layer comprises a slightly compressed phenolic resinous layer, in particular a textile scrim or felt layer. It is understood that the expert may choose any suitable sound absorptive material, in particular open celled foams. This sound absorbent layer may be provided with a second water and oil repellent layer, in particular a textile scrim or felt layer, on the side towards the engine compartment floor or the ground.

The partitioning layer can also be made of several joinable and mutually complementary sections if this is suitable for the specific assembly requirements within the engine compartment.

A further development of the partitioning layer according to the invention foresees at least one acoustically effective aperture in order to increase the acoustic absorptive effects related to Helmholtz resonators. In addition, these apertures may also serve to drain water or oil residues or other liquid waste material out of the cavity. The expert may also consider to form a plurality of such cavities within the engine compartment, which cavities may have differing volumes in order to tune the acoustic properties.

Regarding the properties that influence the overall acoustic performance of a vehicle, transmission loss and absorption coefficient, and considering the improvement in transmission loss as of secondary importance, the use of an engine compartment partitioning layer according to the invention effectively reduces the acoustic energy leakage out of the engine compartment. Measurements prove that the absorption coefficient of a configuration according to the present invention shows a considerable increase in the frequency ranges between 100-400 Hz and 1000-5000 Hz. The improvements at higher frequencies can be related to the airflow resistance of the scrim layer, while the improvements in the lower frequency range are essentially due to the absorptive effect of the cavities.

The invention is described in more detail by way of an exemplary embodiment and with the aid of the Figures.

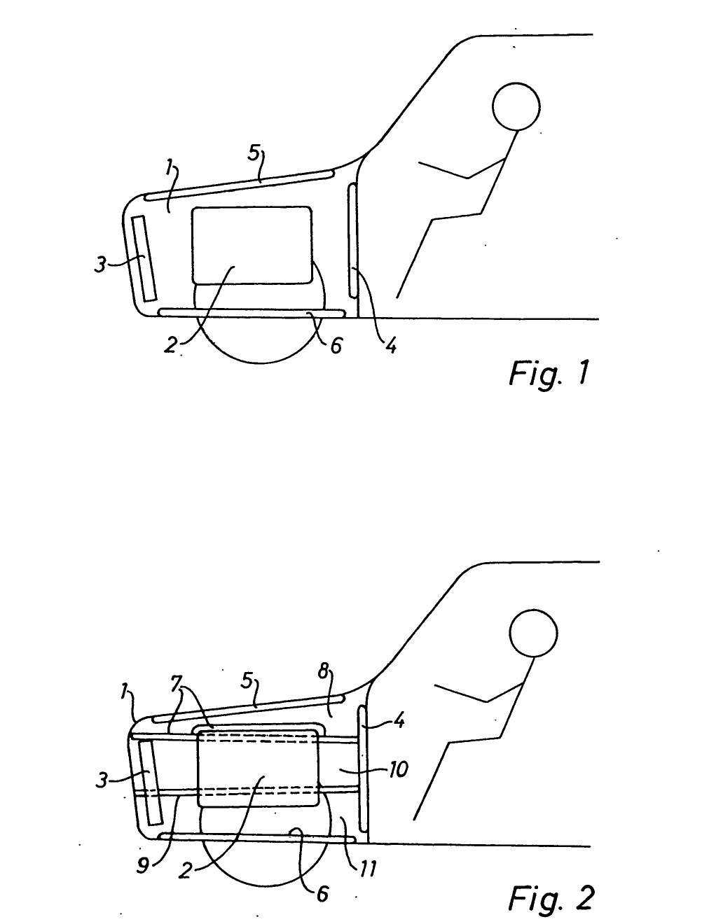

FIG. 1 shows a schematic cross-section of an engine compartment with a conventional sound absorbing lining according to the state of the art;

FIG. 2 shows a schematic cross-section of an engine compartment having a partitioning layer according to the invention;

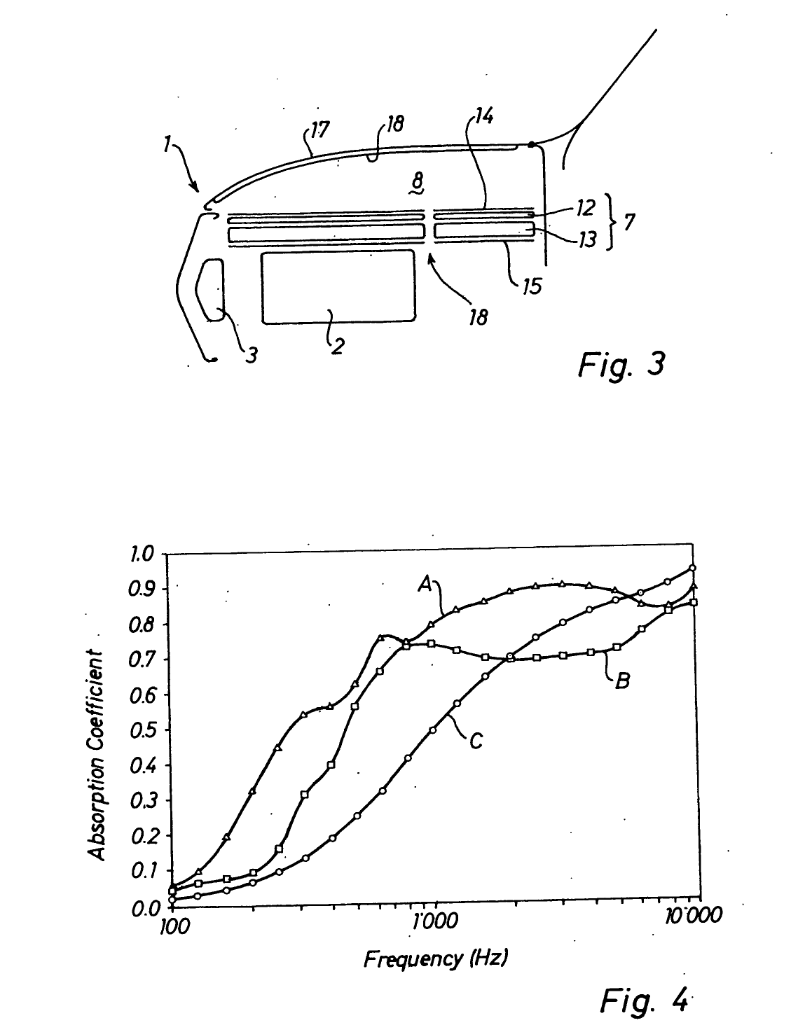

FIG. 3 shows a schematic cross-section of an engine compartment comprising a partitioning layer according to the invention in greater detail than shown in FIG. 2; and

FIG. 4 is a diagram showing the frequency dependence of the absorption coefficient of a configuration according to the invention.

The schematic cross-section according to FIG. 1 shows an engine compartment 1 in which an engine 2 and a vehicle unit or aggregate 3 are arranged. This engine compartment 1 is provided with sound damping linings, and in particular with a front wall lining 4 and an engine hood lining 5. Vehicles are also known which have an engine floor lining 6. Such linings are well known to the expert and are not the object of the present invention.

The schematic cross-section according to FIG. 2 shows an engine compartment 1 which is equipped with an engine compartment partitioning layer 7 according to the present invention. On the one hand, this partitioning layer 7 lies immediately above the engine 2 and, on the other hand, forms an essentially closed, acoustically effective cavity 8 in the closed engine compartment 1. In a preferred embodiment of the invention, this partitioning layer 7 is dual layered and comprises on the engine hood side a carrier layer 12, in particular a compressed felt layer containing phenolic resin and is provided with a first water and oil repellent layer 14, in particular a textile scrim, nonwoven or felt layer. Towards the engine compartment floor or towards the ground the dual layered partitioning layer 7 comprises a second water and oil repellent layer 15, in particular a slightly compressed felt layer (sound absorptive layer) containing phenolic resin. Furthermore, the engine compartment 1 shown in FIG. 2 has a conventional engine hood lining 5 and a conventional front wall lining 4. By adding a second partitioning layer 9 a second cavity 10 is formed, or a third cavity11, if the engine compartment 1 is provided with a floor lining 6. These partitioning layers (6, 7, 9) are designed in such a manner that they can follow the contours of the engine 2 or other vehicle units or aggregates 3 in the engine compartment 1. They may also be designed in such a manner that openings in these partitioning layers allow the individual units or aggregates to protrude through these in a close fitting manner, i.e. in a collar-like manner.

It is to be understood that the partitioning layers 7, 9 according to the invention are formed in such a manner that they can be easily removed from the engine compartment 1 for purposes of vehicle maintenance. The partitioning layers 7, 9 can preferably be made by joining several sections. Suitable joining means are well known to the person skilled in the art.

FIG. 3 shows a more detailed schematic view through an engine compartment 1 containing an engine 2 and with a preferred arrangement of the inventive partitioning layer 7. Here, the partitioning layer 7 is arranged on top of the engine and, together with the closed engine hood 17, forms an acoustically effective cavity 8. This partitioning layer 7 consists of a carrier layer 12 and a sound absorbent layer 13. Preferably this dual layered construction comprises a first water and oil repellent layer 14 on the engine hood side as well as a second water and oil repellent layer 15 on the side toward the engine compartment 1 or the ground. Preferably the engine hood 17 is covered on the engine side with a conventional lining material 18. It has proven to be advantageous to foresee a thin air layer between the first and/or second water and oil repellent layers 14, 15 and the partitioning layer 7. This Figure further shows an optional, acoustically effective aperture 16, which might also serve to drain liquid waste material. It is within the skill of the expert to choose suitable materials for designing the inventive engine compartment partitioning layer 7.

FIG. 4 shows a diagram of the frequency dependence of the absorption coefficient of a configuration according to the invention. The specific configuration used for calculating the acoustic properties, in particular the absorption coefficient, is as follows:

a 0.8 mm thick steel plate (representing the engine hood),

a 0.001 mm deep air space,

a 1 mm thick lining material,

a 20-50 mm deep air space (representing the cavity),

a 1 mm thick first water and oil repellent layer, made of 100 g/m² PET felt plus 20 g/m² thermoplastic adhesive (e.g. SURLYN®)

a 4 mm thick carrier layer made of 1200 g/m² phenolic felt

a 20 mm thick sound absorbent layer made of 500 g/m² PET felt, covering 80% of the total surface;

a 1 mm thick second water and oil repellent layer, made of 80 g/m² PET felt plus 20 g/m² thermoplastic adhesive.

This arrangement corresponds to the arrangement shown in FIG. 3. The values of the frequency dependent absorption coefficient related to this arrangement are shown in curve A of FIG. 4.

In order to demonstrate the performance of the inventive concept, comparative calculations were made for a conventional multilayer hood liner comprising:

a 0.8 mm thick steel plate;

a 0.001 mm thin air layer;

a 20 mm thick absorptive layer (Thinsulate™, covering 80% of the total surface);

a 4.7 mm thick compressed felt (carrier)

The values of the frequency dependent absorption coefficient related to this comparative arrangement are shown in curve B of FIG. 4.

Finally, curve C of FIG. 4 shows the values of a simple 20 mm thick standard felt, which curve makes obvious the improvement obtained by the present invention.

The advantages of the inventive engine compartment partitioning layer are immediately evident and are to be seen in particular in the reduction of sound emission towards the vehicle exterior in the desired frequency range, such as occurs in city traffic with a loaded or unloaded vehicle. This reduction in sound emission is a result of the increased transmission loss caused by the inventive partitioning layer. It is to be understood that by using several partitioning layers these annoying sound emissions can be further reduced. In particular, the acoustic efficacy of the individual cavities formed according to the invention can be optimized by suitable design and by providing further acoustically efficient lining parts as well as by providing suitable acoustically effective apertures in the individual partitioning layers.

A further advantage is to be seen in the weight reduction as compared to conventional liner concepts. In particular, the use of such lightweight partitioning layers allows to replace conventional heavy layer damping materials

First measurements of such a configuration have shown that use of a partitioning layer 7 has led to a reduction in the emitted sound level (an increase of transmission loss) of approx. 4 dB in the range of 800-2000 Hz.

During these measurements, the absorption coefficient in this frequency range was between 0.2 and 0.85. A dual layered partitioning layer 7 was used for these measurements, whose carrier layer 12 had a density of 450 kg/m³ and an air flow resistance of 2400 Rayls and whose absorbent layer 13 had a density of 80 kg/m³ and an air flow resistance of 600 Rayls.

Further developments of the partitioning layer according to the invention can comprise heat protective, sound absorptive or electrically conductive elements.

1. Engine compartment partitioning layer (7) for use in an engine compartment (1), wherein said partitioning layer (7) partitions the engine compartment (1) and forms at least one acoustically effective cavity (8) within the closed engine compartment (1).

2. Partitioning layer (7) according to claim 1, wherein said partitioning layer (7) consists of a carrier layer (12) and a sound absorbent layer (13).

3. Partitioning layer (7) according to claim 2, wherein said carrier layer (12) comprises a compressed phenolic resinous nonwoven layer.

4. Partitioning layer (7) according to claim 3, wherein said carrier layer (12) is provided with a first water and oil repellent layer (14), in particular a textile scrim or felt layer, on the engine hood side.

5. Partitioning layer (7) according to claim 2, wherein the sound absorbent layer (13) comprises a slightly compressed phenolic resinous layer, in particular a textile scrim or felt layer.

6. Partitioning layer (7) according to claim 5, wherein the sound absorbent layer (13) is provided with a second water and oil repellent layer (15), in particular a textile scrim or felt layer, toward the engine compartment floor or the ground.

7. Partitioning layer (7) according to one of claims 1 to 6, wherein said partitioning layer (7) is made of several joinable and mutually complementary sections.

8. Partitioning layer (7) according to one of claims 1 to 7, wherein said partitioning layer (7) is provided with at least one acoustically effective aperture (16).

9. Use of an engine compartment partitioning layer (7) according to claim 1 within an engine compartment (1).

10. Use of several engine compartment partitioning layers (7, 9) according to claim 1 within an engine compartment (1) for forming a plurality of acoustically effective cavities (8, 10) within the engine compartment (1).

11. Use of several engine compartment partitioning layers (7, 9) according to claim 9, wherein said cavities (8, 10) have differing volumes.
